(19) United States
(12) Patent Application Publication
(10) Pub. No.: US 2004/0086025 A1
(43) Pub. Date: May 6, 2004

(54) Apparatus and method for controlling temperature of a film sealing element

(76) Inventors: Thomas P. Orsini, Leominster, MA (US); Russell T. Christman, Dunstable, MA (US)

Correspondence Address: Kevin S. Lemack, Nields & Lemack, 176 E. Main Street, Westboro, MA, 01581, US

(21) Appl. No.: 10/286,434

(22) Filed: Nov. 1, 2002

(51) Int. Cl. G01K 7/02

(52) U.S. Cl. 374/179

(57) ABSTRACT

Apparatus and method for controlling current input to an electrical resistance element such as a seal blade. A heating sensing element such as a thermocouple monitors the temperature of a component of the sealing jaw, such as a conductive mounting member supporting the seal element. When the sensed temperature is above or below a predetermined value, the duration of the impulse current is modified until the temperature falls within a predetermined range or to a predetermined value.

### BACKGROUND OF THE INVENTION

Packaging machines for wrapping and sealing plastic film about an article conventionally utilize a heated wire to seal film layers to one another and to melt through the layers in order to separate one article from another as the articles pass through the machine. Current is supplied to the wire to heat the wire to a high temperature in order to effect the seal and cutting operation. The appearance of the resulting seal is fine and neat as the film shrinks tightly around the package, especially where polypropylene films are involved. Such hot wires are typically used to form both end seals and side seals.

L-bar sealers are generally used to seal heat shrinkable plastic centerfolded film around an object to be packaged. The object to be packaged is wrapped with the film, and the L-sealer is lowered to cut and seal together abutting surfaces of the centerfold film. The L-bar makes two seals at one time, sealing both the edge of the centerfold wrap and also cutting and sealing across the width. Films such as polypropylene, PVC and polyethylene are typically sealed with L-bar sealers. The sealers can be manual, semi-automatic or fully automatic.

As the sealing element contacts the film and performs its intended function, it loses heat to the film as well as to the surrounding environment. Accordingly, current must be continually or continuously supplied to the sealing element in order to maintain the appropriate temperature to perform the intended operation.

Often the sealing element is a hot knife mounted from a pivot and isolated from the machine frame. However, such sealing elements provide a relatively unattractive seal. In order to provide more attractive seals, a resistive element such as a wire (approximately 45-50 thousandths of an inch in diameter) or blade can be used. However, such sealing elements are susceptible to temperature build-up, fatigue and failure. For example, if the current to the wire is not properly controlled and the wire temperature becomes too high, the wire tends to break. As machine speed increases, the current impulse sent to the seal wire to heat the wire to the appropriate temperature becomes more and more frequent, until such point that the seal system is, in effect, on at all times. The wire becomes more susceptible to failure as the film being sealed is not drawing away the excess heat (acting as a heat sink) as fast as the heat is being applied to the wire. The wire eventually softens, stretches, and breaks. This is a common occurrence particularly when proper operator attention is absent. Changing the wire requires that the machine be shut down, resulting in considerable loss of productivity.

In addition, heating the sealing element causes a corresponding temperature increase in adjacent components as well as the framework of the apparatus, which can be highly undesirable. Indeed, where the framework is constructed of a polymeric material, excess heat migrating into the polymeric components can melt the same.

It therefore would be desirable to provide a seal system for an L-type sealing apparatus that detects when one or more adjacent components to the seal element are too hot or are becoming too hot, and responds by reducing or terminating the heating of the element.

These and other objects will be made apparent by reference to the following description and drawings.

### SUMMARY OF THE INVENTION

The problems of the prior art have been overcome by the present invention, which provides a method and apparatus for controlling the temperature of a seal element in a film sealing machine. The present invention involves the integration of a heat sensing device into a component of the sealing jaw that absorbs residual heat from the seal element. Upon sealing application the heat sensing device continuously senses the temperature of the component. The invention utilizes a closed loop feedback system to regulate the duration of the applied power to the sealing element.

In a preferred embodiment, the heat sensing device is a thermocouple that senses the temperature of the heat sensing element holder, and the duration of the power applied to the seal element is maintained, increased, reduced or terminated in response to the sensed temperature. The closed loop control can be repeated as needed for sealing quality and safety. Thus, heat input to the seal element is in an impulse heat mode, in which a specific duration pulse of current through the seal element is applied as the seal element engages the film. The duration of the impulse mode is generally responsive to the rapidity of the sealing cycle. The duration of the impulse is adjusted when the temperature sensing device senses a temperature above a predetermined level or below a predetermined level, in order to maintain the temperature of adjacent or near-by components within a desired range or at a desired specific value.

### BRIEF DESCRIPTION OF THE DRAWING

FIG. 1 is a perspective view of a seal jaw in an L-seal assembly in accordance with the present invention;

FIG. 2 is an exploded view of a termination block of the seal jaw of FIG. 1;

FIG. 2A is a cross-sectional view of the termination block of FIG. 2;

FIGS. 3 and 3A are views of the jaw assembly of the seal jaw of FIG. 1;

FIG. 4 is an exploded view of a seal element mount with an integrated thermocouple in accordance with the present invention; and

FIG. 5 is a flow chart of steps taken to carry out the method of the present invention.

### DETAILED DESCRIPTION OF THE INVENTION

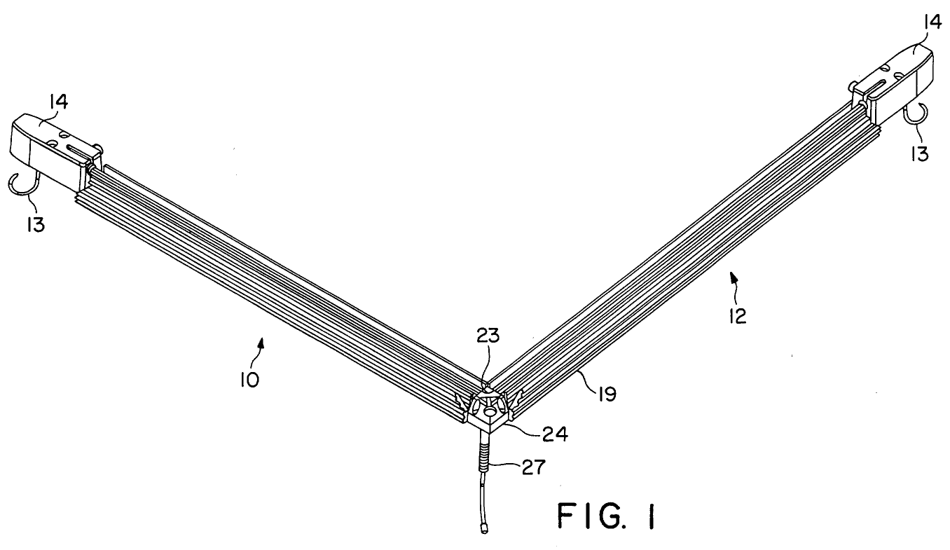

Turning now to FIG. 1, there is a shown a portion of an L-seal apparatus for a packaging machine in accordance with an embodiment of the present invention. The bottom of the L-bar includes a front jaw assembly 12 and a cross jaw assembly 10. For purposes of illustration, the cross jaw assembly 10 will be discussed to illustrate the construction of the L-bar, although those skilled in the art will appreciate that analogous components are used to make up the front jaw assembly 12.

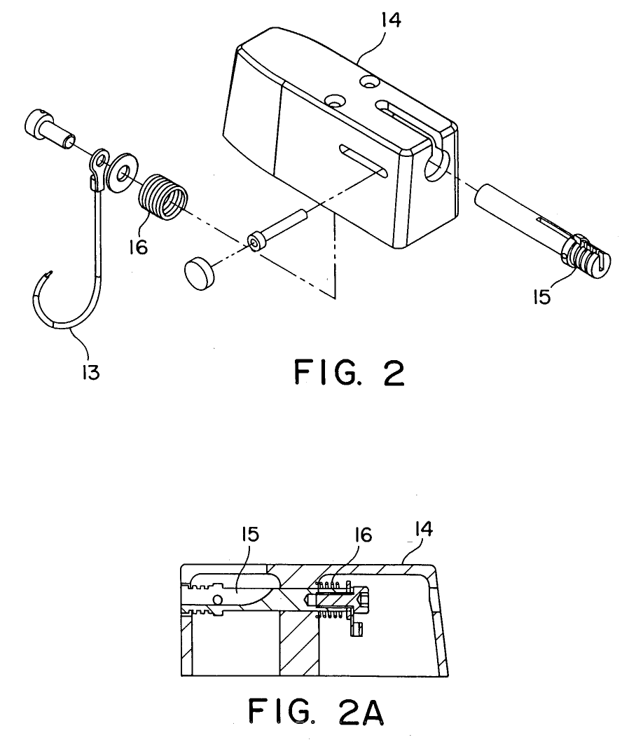

A termination block 14 (best seen in FIG. 2) is located at each of the ends of the L-bar and holds the sealing element in place. To that end, a sealing element is supported in slotted sealing element terminal 15, and the terminal 15 rides in the block 14 to accommodate expansion and contraction of the sealing element due to its temperature variations. Compression spring 16 biases the terminal 15 inwardly as best seen in FIG. 2A, thereby allowing the terminal 15 to accommodate the expansion and contraction of the seal element. A TEFLON shielded wire 13 is in electrical communication with the seal element and with a current supply source (not shown) for providing current to the sealing element to heat the element to the desired temperature.

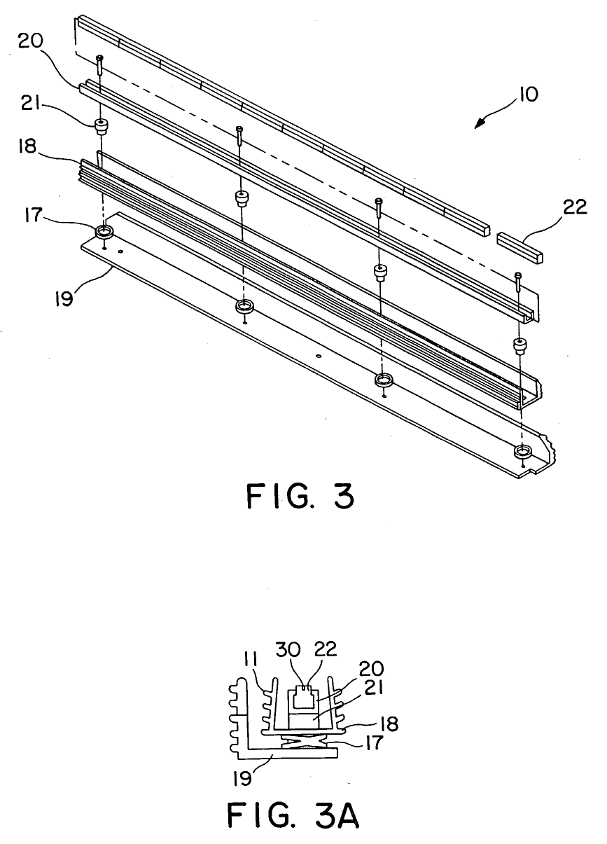

FIGS. 3 and 3A illustrate the various components of the bottom cross jaw assembly 10. Wave springs 17 support film clamp 18 on cross guard 19 as shown, and bias the film clamp 18 towards the film during sealing. The cross guard 19 is preferably constructed of a conductive material, preferably aluminum, and acts as a heat sink to assist in dissipating heat from the sealing element. The opposite sides of film clamp 18 extend upwardly at an inward angle, and surround bottom jaw 20 that sits inside the opposite sides on spacers 21. The spacers 21 support the bottom jaw away from the cross guard 19 and isolate heat away from the cross guard 19. Preferably the opposite sides of the clamp 18 include one or more upwardly sloping projections 11 that serve as a heat sink to dissipate heat from the sealing element. The opposite sides terminate in respective free ends that provide the surface against which the film is sandwiched during sealing. These surfaces effectively clamp the film being sealed in place, keeping it taut during the sealing operation to effect a high quality seal. The wave springs 17 on which the clamp 18 sits allow for flexibility as the top seal arm is compressed over the film to make the seal. The bottom jaw 20 supports insulator 22 that is formed with a central slot (FIG. 3A) to hold the sealing element 30 and insulate it against heat and voltage.

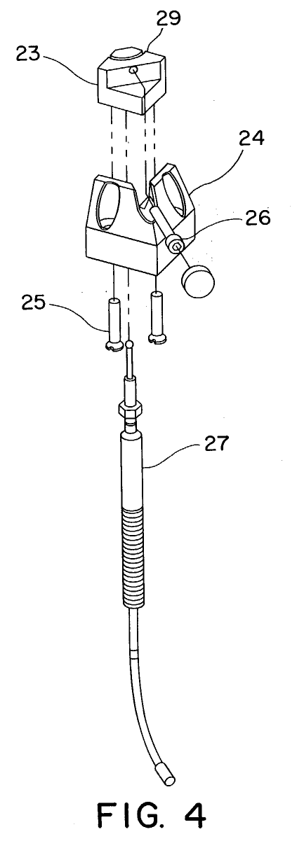

Turning now to FIG. 4, the edge assembly of the bottom jaw is illustrated. Corner block 23 is coupled to corner mount 24 by any suitable means, such as with slotted screws 25 and hex screw 26. The corner block 23 is made of a thermally conductive material, preferably brass. A heat sensing element 37 such as a thermocouple is positioned to sense a temperature of a component that is heated by the sealing element. Since sensing the temperature of the sealing element directly is often difficult due to the lack of surface area of the sealing element, preferably the heat sensing element 37 is positioned to sense the temperature of one or more adjacent or near-by components in the jaw, most preferably the corner block 23. Although this temperature can be correlated to the actual temperature of the sealing element (knowing the actual correlation between the temperature of the component sensed and the temperature of the sealing element not being important for the purposes of the present invention), it is often well below the actual temperature of the sealing element. Monitoring the mounting block temperature rather than directly monitoring the sealing element temperature effectively achieves an objective of the present invention of keeping components adjacent or near the sealing element cool, and keeping the frame of the apparatus cool. Preferably the heat sensing device is in direct contact with the corner block 23, although positioning the sensing device in close proximity to the corner block 23 also is suitable. Those skilled in the art will appreciate that the present invention is not limited to monitoring the temperature of the corner block 23; it is within the scope of the present invention to monitor the temperature of one or more other components of the apparatus whose temperatures correlate to or are indicative of the sealing element temperature, such as the cross guard 19 or the terminal 15 in termination block 14. Preferably such components are in thermal contact with the sealing element.

The sensing device 27 is also in electrical communication with a controller board (not shown). The sealing element (not shown) is positioned in curved slot 29 of the corner block where it makes the turn from the cross jaw to the front jaw. The sealing element is in good thermal contact with the corner block 23, so that the temperature of the corner block 23 substantially correlates to the temperature of the sealing element. As stated above, for the purposes of the invention it is not necessary that the actual correlation between the temperature of the block 23 and the sealing element be known. Since the corner block 23 and sensing device 27 are centrally located along the length of the sealing element (the cross jaw and front jaw are about the same length), the temperature sensed by the sensing device 27 is an excellent indication of the average temperature of the components that are effected by the residual heat from the sealing element.

In a preferred embodiment of the present invention, heat is input to the seal element 30 in an impulse mode. For example, at the point of jaw closure where the hot seal element is pressing the film layers against a sealing pad surface, the closure of the top jaws activates a detection circuit that then triggers a specific duration of pulse of current through the seal element 30 to increase the temperature of the element to physically produce a seal and cut. The impulse replaces the heat that the seal wire loses during the sealing process, such as to the two webs of film and to the opposite seal surface, and the heat lost to the surrounding environment and near-by components, particularly between seals. The suitable amount of current for the impulse mode and the duration of the impulse depends in part on the gauge and type of film to be sealed and the desired quality of the seal. The present inventors have found that a voltage of 42 volts and a current of 48 amps is suitable for films typically used in L-bar sealers of this type. The current is kept constant; only the duration of the current is modified in response to the sensed temperature. Preferably the impulse duration may be from about 0.1 seconds to about 1.5 seconds, most preferably about 1 second.

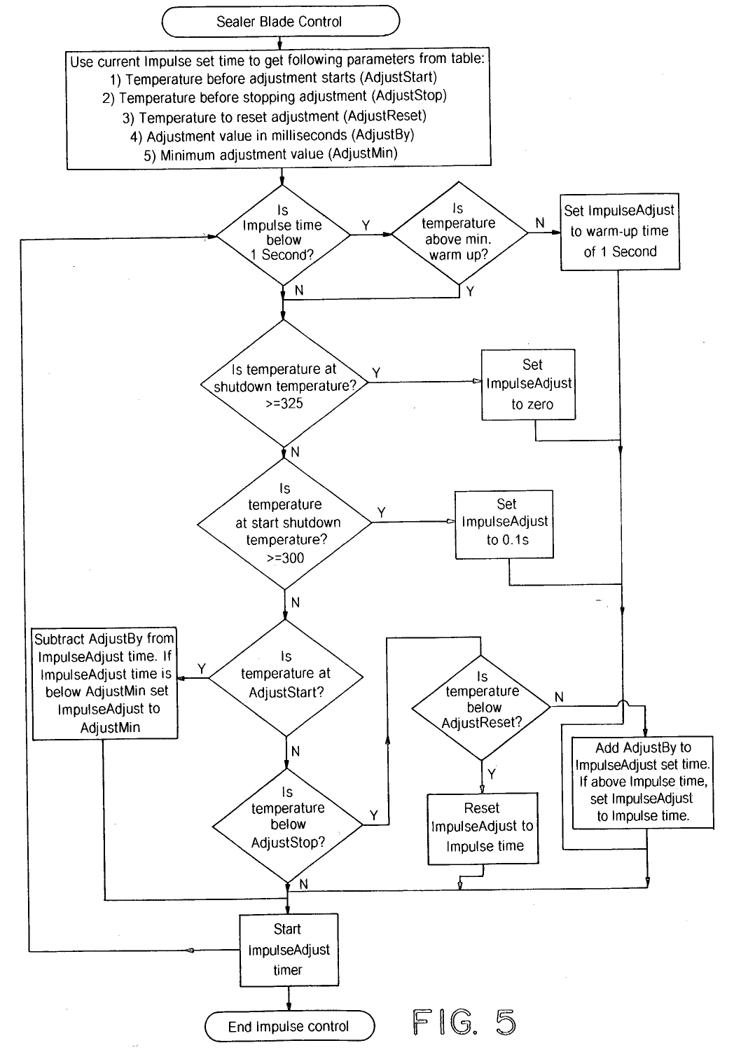

In accordance with the present invention, the heat sensing element 27 continuously or continually monitors the temperature of the block 23. When the sensed temperature exceeds a predetermined value or range of values, the control board reduces the duration of the impulse a predetermined amount. One method for determining an appropriate temperature above which is considered excessive, thereby triggering the reduction of impulse current duration, is to determine the impulse current duration time set by the operator. From the impulse duration time selected, based on experience the operator can estimate the appropriate temperature of the sealing element (based, for example, on the nature of the film and the operating speed), and a suitable temperature above this estimated temperature is chosen above which would be considered excessive. A similar operation can be carried out to determine the minimum temperature necessary to effectuate a seal. For example, with reference to FIG. 5, if the operator sets an impulse duration of 1.5 seconds, it can be assumed that the desired sealing element temperature for a given film is about 270° F. (or a range of temperatures, such as from about 260 (“AdjustStop” to about 280° F. (“AdjustStart”). The controller then can be instructed to reduce the impulse duration by a certain amount (“AdjustBy”), e.g., 0.2 seconds, if the mounting block temperature sensed exceeds the desired temperature range. After the adjustment, if the sensed temperature does not lower sufficiently (e.g., back into the acceptable range), the impulse duration is reduced again, for example by another 0.2 seconds, and this process is repeated until the desired temperature or temperature range is again achieved. Similarly, if the temperature is below the desired value or range of values (i.e., below “AdjustStop”), the impulse duration can be increased, such as by increments of 0.2 seconds, until the desired value or range of values is achieved. Those skilled in the art will appreciate that incremental values of impulse duration adjustment other than 0.2 seconds can be used, and that the particular increment need not be the same throughout the process. This process is illustrated in the flow diagram of FIG. 5. Those skilled in the art will appreciate that at start-up, when the sealing element is not yet at temperature, a predetermined amount of time to increase the impulse time in order to get the sealing element up to temperature can be provided (exemplified as 1 second in the chart of FIG. 5). In addition, if the sensed temperature cools below a certain predetermined value (such as a value that is below the “AdjustStart” value by twice the amount of the difference between the “AdjustStart” temperature and the “AdjustStop” temperature), it is assumed that the operation of the sealer has been temporarily halted, and in order to avoid the time necessary to ramp the temperature up incrementally, the impulse time can be reset to the original impulse time. As a safety measure, the controller also can terminate impulse current to the sealing element completely in the event the sensed temperature exceeds a predetermined value.

As a result, the seal element holder, the film clamps, the framework of the apparatus, and other adjacent components are kept relatively cool. Indeed, because of the excessive temperatures occurring in the prior art devices, a film clamp either could not be used, or required cooling with a cooling fluid that required extensive engineering and was problematic.

Suitable sealing elements 30 include wires, bars and blades. Preferably the sealing element 30 is an elongated blade having a uniform cross-section. The uniform cross-section allows the blade to be turned over in the event the cutting edge becomes dull, thereby doubling its useful life.

### EXAMPLE 1

The maximum impulse time in this example is 1.5 seconds. The controller is programmed so that if the sensed temperature reaches 300° F., the impulse is set to 0.1 seconds, and as a safety, if the sensed temperature reaches 325° F., the impulse is turned off. The desired temperature range is from 260° F. to 280° F.

If the sensed temperature reaches 280° F., the impulse time is scaled back 0.2 seconds to 1.3 seconds. If the sensed temperature continues to increase, the impulse time is scaled back another 0.2 seconds to 1.1 seconds. This process is continued until the sensed temperature is within the desired range.

If the sensed temperature drops below 260° F., the impulse time is increased by 0.2 seconds to 1.1 seconds. If the sensed temperature is still below 260° F., the impulse time is increased another 0.2 seconds to 1.3 seconds, and so forth.

This process of incrementally modifying the impulse time so that the sensed temperature is maintained within the desired range is repeated.

What is claimed is:

1. Apparatus for sealing a plastic film, comprising:
at least one jaw housing a sealing element;
a source of impulse power to heat said sealing element over a predetermined amount of time to a temperature effective for sealing said plastic film;
a temperature sensor for sensing the temperature related to the temperature of said sealing element;
a controller responsive to said sensed temperature for modifying the duration of said impulse power applied to said sealing element when said sensed temperature falls outside a predetermined range.

2. The apparatus of claim 1, further comprising a thermally conductive mounting member in said at least one jaw for mounting said sealing element, and wherein said temperature related to said temperature of said sealing element is the temperature of said mounting member.

3. The apparatus of claim 1 or 2, wherein there are two jaws positioned orthagonally with respect to one another.

4. The apparatus of claim 3, wherein one of said jaws seals a side of said film, and the other of said jaws seals a trailing edge of said film.

5. The apparatus of claim 1 or 2, wherein said sensing device comprises a thermocouple.

6. The apparatus of claim 2, wherein said sensing device is in intimate contact with said mounting member.

7. The apparatus of claim 2, wherein said mounting member comprises brass.

8. The apparatus of claim 3, wherein said mounting member is positioned at the intersection of said two jaws.

9. The apparatus of claim 1, further comprising a film clamp in said at least one jaw.

10. The apparatus of claim 1, wherein when said sensed temperature exceeds said predetermined range, the duration of said impulse is reduced.

11. The apparatus of claim 1, wherein when said sensed temperature is below said predetermined range, the duration of said impulse is increased.

12. A method for controlling the temperature of one or more components in a jaw of a sealing apparatus, comprising:
providing an electrical resistance heating element in said jaw;
applying an impulse current for a predetermined duration to said element to heat said element;
monitoring the temperature of at least one of said components in said jaw;
modifying the duration that said current is applied to said element when said sensed temperature is outside a predetermined range.

13. The method of claim 12, wherein said electrical resistance heating element is mounted in a thermally conductive mounting member, and wherein said at least one component comprises said mounting member.

14. The method of claim 12, wherein said step of modifying the duration that said current is applied increases the duration of the current that is applied to said element when said sensed temperature is below said predetermined range.

15. The method of claim 12, wherein said step of modifying the duration that said current is applied decreases the duration of the current that is applied to said element when said sensed temperature exceeds said predetermined range.

16. Apparatus for sealing a plastic film, comprising:
at least one sealing jaw;
a sealing element mounted in said jaw with a thermally conductive mounting member;
a source of impulse power to heat said sealing element over a predetermined amount of time to a temperature effective for sealing said plastic film;
a temperature sensor for sensing the temperature of said mounting member;
a controller responsive to said sensed temperature for modifying the duration of said impulse power applied to said sealing element when said sensed temperature falls outside a predetermined range.
